(19) United States
(12) Patent Application Publication
(10) Pub. No.: US 2014/0176327 A1
(43) Pub. Date: Jun. 26, 2014

(54) METHOD AND APPARATUS FOR DETERMINING THAT MEDICAL ASSISTANCE MAY BE REQUIRED

(71) Applicant: NOKIA CORPORATION, Espoo (FI)

(72) Inventors: Rita Parada, San Francisco, CA (US); Lina Ester Liner, Palo Alto, CA (US); Charlie Matthew Sutton, San Francisco, CA (US); Brody Jay Larson, San Mateo, CA (US); Michelle Christine Shilstone, San Rafael, CA (US); Laura Gigi Lee, San Francisco, CA (US); Nick John Foster, San Francisco, CA (US); Markus Eklund, Pleasanton, CA (US)

(73) Assignee: NOKIA CORPORATION, Espoo (FI)

(21) Appl. No.: 13/722,356

(22) Filed: Dec. 20, 2012

(51) Int. Cl. G08B 21/02

(52) U.S. Cl. CPC G08B 21/02
USPC 340/539.12

(57) ABSTRACT

A method, apparatus and computer program product are provided in order to provide timely notification of a medical response service of a subject who may require medical assistance. In the context of a method, information regarding a subject is received from an interface system carried by a head worn device of the subject, such as a helmet worn by the subject. The information provided by the interface system is utilized for non-medical purposes. The method also determines whether the subject is considered to require medical assistance based upon the information regarding the subject. The method may also include causing notification of a medical response service of the subject in an instance in which the subject is considered to require medical assistance.

### TECHNOLOGICAL FIELD

A method, apparatus and computer program product are provided in accordance with an example embodiment in order to determine if a subject requires medical assistance and, more particularly, to determine if the subject requires medical assistance based upon information provided by an interface system carried by a head worn device of the subject.

### BACKGROUND

In certain situations, an individual may require medical assistance with the responsiveness with which the medical assistance is provided oftentimes being of import with respect to the manner in which the individual recovers, if at all. It may sometimes be difficult, however, for an individual who requires medical assistance to request the medical assistance. For example, in instances in which an individual is alone and is stricken with a medical emergency, the individual may be unable to place a telephone call to alert a medical response service, such as a police department, the emergency response unit of a hospital or other first responder, of the medical emergency. In this regard, the medical emergency may render the individual unconscious or otherwise unable to place a telephone call such that the timeliness with which the individual receives medical assistance is delayed. This delay may, in turn, have a deleterious impact upon the recovery of the individual from the medical condition.

In one example, an individual may be riding a motorcycle. In this scenario, the motorcyclist may have an accident and may be rendered unconscious or otherwise unable to place a telephone call requesting medical assistance. As such, the motorcyclist may be required to wait until the accident scene is discovered by another person who may then report the accident and request medical assistance for the motorcyclist. The delay in the motorcyclist receiving medical attention may disadvantageously impact the recovery of the motorcyclist from the accident. In this regard, some motorcyclists may ride in relatively remote areas or across relatively rugged terrain such that a substantial period of time may pass between an accident and the discovery of the accident scene by another person, thereby potentially putting at risk the recovery of the motorcyclist from their medical condition.

### BRIEF SUMMARY

A method, apparatus and computer program product are provided according to an example embodiment in order to notify a medical response service of a subject who may require medical assistance in a more timely manner. In this regard, the method, apparatus and computer program product of an example embodiment are not dependent upon the discovery of the subject requiring medical assistance by another person, but may independently and automatically notify the medical response service of the subject who may require medical assistance, even in an instance in which the subject is unable to initiate or otherwise participate in the notification of the medical response service. Thus, the method, apparatus and computer program product of an example embodiment may allow the subject to receive more timely medical assistance which may, in some instances, facilitate the subject's recovery from their medical condition.

In one embodiment, the method is provided that includes receiving information regarding a subject from an interface system carried by a head worn device of the subject, such as a helmet worn by the subject. The information provided by the interface system is utilized for non-medical purposes. The method of this embodiment also determines, with a processor, whether the subject is considered to require medical assistance based upon the information regarding the subject. The method may also include causing notification of a medical response service of the subject in an instance in which the subject is considered to require medical assistance.

The interface system may include a gaze tracking system. In this embodiment, the method may determine whether the subject is considered to require medical assistance by determining whether the subject is considered to have become impaired based upon information regarding the subject provided by the gaze tracking system. Further, the method of this embodiment may determine whether the subject is considered to have become impaired by determining whether the subject is considered to require medical assistance based upon a comparison of a length of time that eyes of the subject remain closed relative to a predefined threshold. Additionally or alternatively, the method of this embodiment may determine whether the subject is considered to have become impaired by determining whether the subject is considered to require medical assistance based upon pupil dilation of the eyes of the subject.

The method of one embodiment may also include considering additional information regarding the subject in an instance in which the subject is considered to require medical assistance in order to confirm that the subject is considered to require medical assistance prior to causing notification of the medical response service. In one embodiment, the head worn device is configured for use by the subject during performance of a predefined activity. The method of this embodiment may also include utilizing the information provided by the interface system during performance of the predefined activity for non-medical purposes.

In another embodiment, an apparatus is provided that includes at least one processor and at least one memory including computer program code with the at least one memory and computer program code configured to, with the processor, cause the apparatus to at least receive information regarding a subject from an interface system carried by a head worn device of the subject, such as from the interface system carried by a helmet worn by the subject. The information provided by the interface system is utilized for non-medical purposes. The at least one memory and the computer program code are configured to, with the processor, cause the apparatus of this embodiment to determine whether the subject is considered to require medical assistance based upon the information regarding the subject and to cause notification of a medical response service of the subject in an instance in which the subject is considered to require medical assistance.

The interface system may include a gaze tracking system. In this embodiment, the at least one memory and the computer program code are configured to, with the processor, cause the apparatus to determine whether the subject is considered to require medical assistance by determining whether the subject is considered to have become impaired based upon information regarding the subject provided by the gaze tracking system. In this embodiment, the at least one memory and the computer program code may be configured to, with the processor, cause the apparatus to determine whether the subject is considered to have become impaired by determining whether the subject is considered to require medical assistance based upon a comparison of a length of time that the eyes of the subject remain closed relative to a predefined threshold. Additionally or alternatively, the at least one memory and the computer program code may be configured to, with the processor, cause the apparatus of this embodiment to determine whether the subject is considered to have become impaired by determining whether the subject is considered to require medical assistance based upon pupil dilation of the eyes of the subject.

The at least one memory and the computer program code may be further configured to, with the processor, cause the apparatus of one embodiment to consider additional information regarding the subject in an instance in which the subject is considered to require medical assistance in order to confirm that the subject is considered to require medical assistance prior to causing notification of the medical response service. In one embodiment, the head worn device is configured for use by the subject during performance of a predefined activity. In this embodiment, the at least one memory and the computer program code may be further configured to, with the processor, cause the apparatus to utilize the information provided by the interface system during performance of the predefined activity for non-medical purposes.

In a further embodiment, a computer program product is provided that includes at least one non-transitory computer-readable storage medium having a computer-executable program code portion stored therein with the computer-executable program code portions including program code instructions for receiving information regarding a subject from an interface system carried by a head worn device of the subject. The information provided by the interface system is utilized for non-medical purposes. The computer-executable program code portions of this embodiment also include program code instructions for determining whether the subject is considered to require medical assistance based upon the information regarding the subject and program code instructions for causing notification of a medical response service of the subject in an instance in which the subject is considered to require medical assistance.

The interface system of one embodiment includes a gaze tracking system. In this embodiment, the program code instructions for determining whether the subject is considered to require medical assistance may include program code instructions for determining whether the subject is considered to have become impaired based upon information regarding the subject provided by the gaze tracking system. In one example embodiment, the program code instructions for determining whether the subject is considered to have become impaired may include program code instructions for determining whether the subject is considered to require medical assistance based upon a comparison of the length of time that the eyes of the subject remain closed relative to a predefined threshold. Additionally or alternatively, the program code instructions for determining whether the subject is considered to have become impaired may include program code instructions for determining whether the subject is considered to require medical assistance based upon pupil dilation of the eyes of the subject.

The computer program product of one embodiment may also include program code instructions for considering additional information regarding the subject in an instance in which the subject is considered to require medical assistance in order to confirm that the subject is considered to require medical assistance prior to causing notification of the medical response service. The head worn device of one embodiment may be configured for use by the subject during performance of a predefined activity. In this embodiment, the computer-executable program code portions may further include program code instructions for utilizing the information provided by the interface system during performance of the predefined activity for non-medical purposes.

In yet another embodiment, an apparatus is provided that includes means for receiving information regarding a subject from an interface system carried by a head worn device of the subject. The information provided by the interface system is utilized for non-medical purposes. The apparatus of this embodiment also includes means for determining whether the subject is considered to require medical assistance based upon the information regarding the subject. The apparatus of this embodiment further includes means for causing notification of a medical response service of the subject in an instance in which the subject is considered to require medical assistance.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a perspective view of a helmet that may carry an interface system that provides information that may be utilized in accordance with an example embodiment of the present invention;

FIG. 2 is a block diagram of an apparatus that may be specifically configured in accordance with an example embodiment of the present invention; and

FIG. 3 is a flowchart illustrating operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

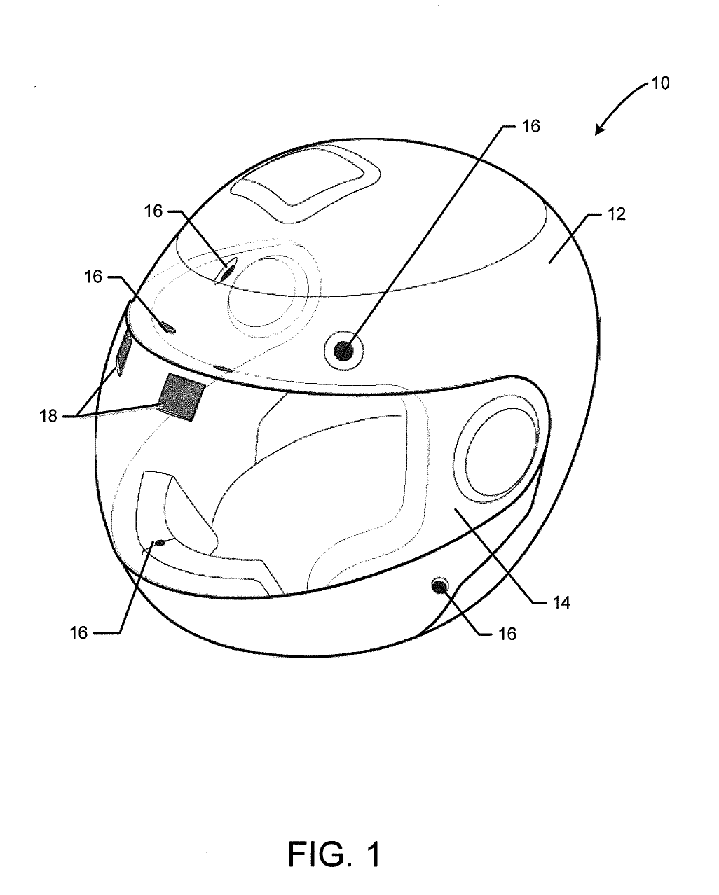

A method, apparatus and computer program product are provided for notifying a medical response service in an instance in which a subject is considered to require medical assistance. The method, apparatus and computer program product of an example embodiment may determine that medical assistance is required based upon information regarding the subject provided by an interface system that is carried by a head worn device of the subject. Various types of head worn devices may carry an interface system that provides information from which the method, apparatus and computer program product of an example embodiment may determine if the subject requires medical assistance. In one example embodiment, however, the head worn device is a helmet 10 that carries one or more interface systems. As shown in FIG. 1, for example, the helmet may include a protective shell 12 and a visor 14 through which the subject views their surroundings. However, the helmet may be differently configured. For example, the helmet need not include a visor. The head worn device, such as the helmet, may be configured to be worn by the subject during the performance of a predefined activity. For example, the helmet may be configured to be worn by the subject while riding a motorcycle, a four wheeler or the like. Additionally or alternatively, the helmet may be configured to be worn by the subject while snow skiing in relatively extreme conditions.

As illustrated in FIG. 1, the head worn device, such as the helmet 10, may include one or more interface systems 16. The interface systems may provide information regarding the subject. The information provided by the interface systems may be utilized for non-medical purposes. For example, in instances in which the head worn device is configured for use by the subject during the performance of a predefined activity, the information provided by the interface systems may be utilized during the performance of the predefined activity for non-medical purposes.

The head worn device may carry a variety of different interface systems 16. For example, the interface systems may include a gaze tracking system 18 for monitoring the gaze of the subject. The gaze tracking system may include, for example, an inwardly facing camera for capturing an image of the eyes of the subject. In an instance in which the head worn device is a motorcycle helmet 12, the gaze tracking system may be utilized while the subject is riding in order to determine the line of sight of the subject which may, in turn, dictate the information that is presented to the subject, such as by being displayed upon the visor 14 of the helmet. The information that is presented to the subject may include, for example, a map or other image of the upcoming terrain along the line of sight of the subject. In another example, the interface system may include a bone conduction audio system for capturing audio signals propagated through the bones of the subject, such as through the jawbone of the subject. In an instance in which the head worn device is a motorcycle helmet, a bone conduction audio system may be utilized for communications by the subject by capturing and transmitting audible signals with less interference from road noise than other types of audio systems. Another example of an interface system may include one or more positioning systems that may be utilized to determine the location of the subject. In an instance in which the head worn device is a motorcycle helmet, the positioning sensors may be utilized, for example, in conjunction with a global positioning system (GPS) in order to provide a map or other information regarding the subject's surroundings during their ride. The head worn device may include still other types of interface systems including one or more audio transducers for playing and/or recording audio signals for communication, entertainment or other purposes, one or more accelerometers, a display or the like. Each of these interface systems that may be carried by a head worn device, such as a helmet, may provide information that may be utilized for non-medical purposes, such as during performance of a predefined activity, e.g., riding a motorcycle, snow skiing or the like.

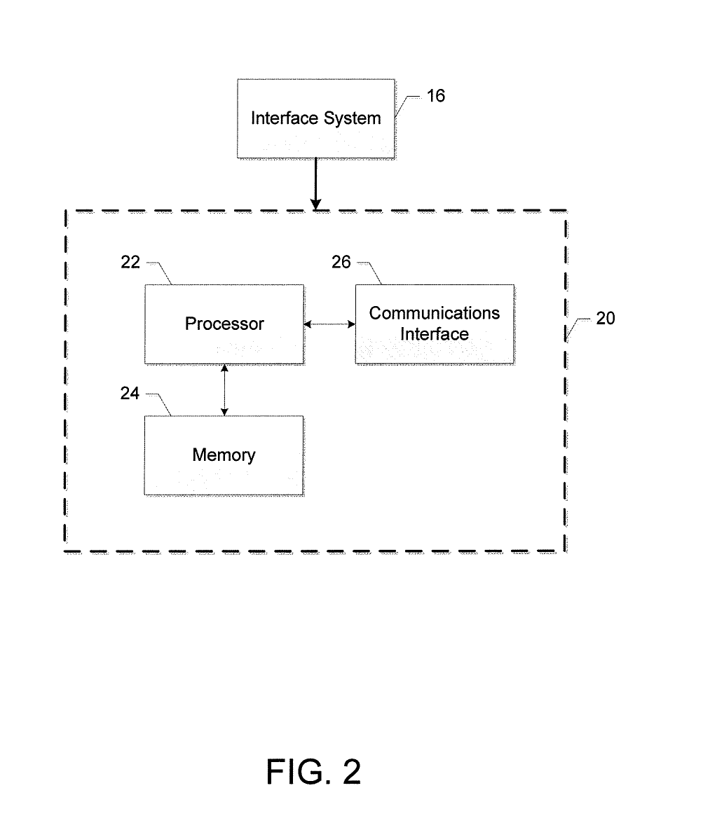

The method, apparatus and computer program product of an example embodiment may utilize the information provided by the interface system 16 carried by a head worn device of the subject in order to determine whether the subject requires medical assistance and, if so, to notify a medical response service of the subject who is in need of medical assistance. As such, the apparatus 20 of one embodiment may be configured is shown in FIG. 2. The apparatus may be entirely embodied by the head worn device, such as a helmet 10, in one embodiment. In other embodiments, however, the interface system may be carried by the head worn device of the subject, but one or more of the elements of the apparatus, such as the processor 22, the memory 24 and/or the communication interface 26, may be embodied by another device, such as a mobile terminal, such as a mobile terminal carried by the subject. In this regard, the mobile terminal that may embody one or more elements of the apparatus may include, for example, a mobile telephone, a smartphone, a personal digital assistant (PDA), a tablet computer, a laptop computer, a touch surface, a gaming device, a camera, an electronic book, a pager, a mobile television, a gaming device, a camera, a video recorder, an audio/video player, a radio, a positioning device (e.g., global positioning system (GPS) device), or any combination of the aforementioned, and other types of voice and text communications systems. In these embodiments in which the interface system(s) is separate from one or more elements of the apparatus, the interface system(s) carried by the head worn device may be in communication with the other elements of the apparatus, such as may be supported by the communication interface, by either wireless communications or wireline communications. In an instance in which the interface system(s) are in communication with the other elements of the apparatus via wireless communications, the wireless communications may include proximity based wireless communication techniques, such as communications via wireless local area network, Bluetooth or the like, or a network-based communications, such as communications via a wide area network, e.g., the internet, a cellular network or the like.

Regardless of the manner in which the apparatus 20 is embodied, the apparatus may include or otherwise be in communication with a processor 22, a memory device 24 and a communication interface 26. In some embodiments, the processor (and/or co-processors or any other processing circuitry assisting or otherwise associated with the processor) may be in communication with the memory device via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

In some embodiments, the apparatus 20 may be embodied as a chip or chip set. In other words, the apparatus 10 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 26 may be any means such as a device or circuitry embodied in either hardware or a combination of hardware and software that is configured to receive and/or transmit data, such as by supporting communications with the interface system(s) 16 and/or a medical response service. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms

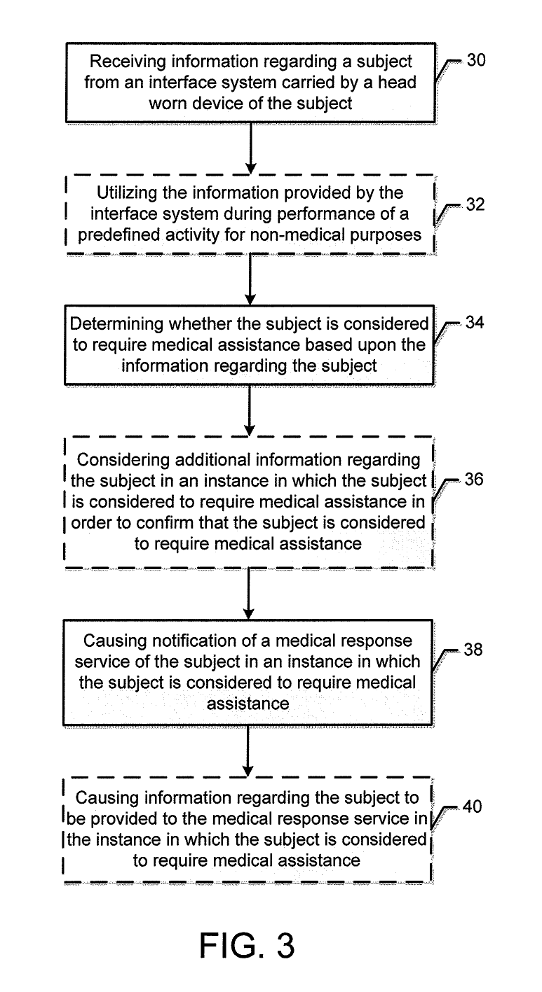

The method, apparatus 20 and computer program product of an example embodiment will now be described in conjunction with the operations illustrated in FIG. 3. In this regard, the apparatus, such as the processor 22, the communications interface 26 or the like, may be configured to receive information regarding a subject from an interface system 16 carried by a head worn device of the subject. As described above, the interface system is configured to provide information that may be utilized for non-medical purposes. In this regard, the head worn device may be configured for use by the subject during performance of a predefined activity. For example, the head worn device may be a helmet 10 configured for use by the subject while riding a motorcycle. As shown in block 32 of FIG. 3, the apparatus, such as the processor or the like, may therefore be configured to utilize the information provided by the interface system during performance of the predefined activity for non-medical purposes, such as those described above. As such, the apparatus may include means, such as the processor, the communications interface or the like, for receiving information regarding the subject from an interface system carried by a head worn device of the subject and means, such as a processor or the like, for utilizing the information provided by the interface system during performance of the predefined activity for non-medical purposes.

The apparatus 20, such as the processor 22 or the like, may also be configured to determine whether the subject is considered to require medical assistance based upon the information regarding this subject. See block 34 of FIG. 3. The apparatus, such as the processor, may be configured to determine that the subject is considered to require medical assistance in various manners. In one embodiment, however, the apparatus, such as the processor, may reference predefined acceptable values or ranges, such as may be stored by the memory device 24, for the information provided by an interface system 16 such that the apparatus, such as the processor, will not consider the subject to require medical assistance so long as the information satisfies or is otherwise consistent with the acceptable value(s) or range. However, in an instance in which the information provided by the interface system deviates from the acceptable value(s) or range, the apparatus, such as the processor, may consider the subject to require medical assistance or may at least require further analysis, such as further analysis of the information provided by the interface system or further analysis of other information, to confirm whether medical assistance is required for the subject. By way of example, the apparatus, such as the processor, may be configured to reference one or more predefined thresholds associated with the information provided by an interface system. In an instance in which the threshold if unsatisfied, the apparatus, such as the processor, may utilize the information provided by the interface system for non-medical purposes. However, in an instance in which the threshold is satisfied, the apparatus, such as the processor, may determine that the subject requires medical assistance or may at least determine that further analysis is required, such as further analysis of the information provided by the interface system or further analysis of other information, in order to determine whether the subject requires medical assistance. As such, the apparatus may include means, such as the processor or the like, for determining whether the subject is considered to require medical assistance based upon the information from the interface system regarding the subject.

The manner in which the apparatus 20, such as the processor 22, determines whether the subject is considered to require medical assistance may vary and, in one embodiment, may depend upon the type of interface system 16 and the information provided by the interface system, the predefined activity that is being performed by the subject as defined by the type of head worn device or the like. In one embodiment in which the interface system is a gaze tracking system 18, however, the apparatus, such as the processor, may be configured to determine whether the subject is considered to require medical assistance by determining whether the subject is considered to have become impaired based upon the information regarding the subject provided by the gaze tracking system. The determination as to whether the subject is considered to have become impaired may be performed in various manners. In one embodiment, the apparatus, such as the processor, may be configured to determine whether the subject is considered to have become impaired by determining whether the subject is considered to require medical assistance based upon a comparison of a length of time that the eyes of the subject remain closed relative to a predefined threshold. In an instance in which the head worn device is a motorcycle helmet 10, the apparatus, such as the processor, may reference a predefined threshold that exceeds the length of time that the eyes of the motorcycle rider are closed while blinking or squinting such that the subject will not be considered to require medical assistance in response to blinks or squints that occur while riding. However, the apparatus, such as the processor, of this embodiment may be responsive to a predefined threshold that is set such that the subject is considered to require medical assistance in an instance in which the subject's eyes remain closed for an extended period of time, which is longer than any reasonably anticipated period of time that the user's eyes would normally remain closed while riding. Thus, the apparatus, such as the processor, may determine that the subject is considered to require medical assistance in an instance in which the subject has wrecked the motorcycle and is rendered unconscious with their eyes being closed for an extended period of time.

Additionally or alternatively, the apparatus 20, such as the processor 22 that receives information from a gaze tracking system 18, may determine whether the subject is considered to have become impaired by determining whether the subject is considered to require medical assistance based upon pupil dilation of the eyes of the subject. In this regard, the apparatus, such as the processor, may be configured to distinguish normal pupil dilation of the eyes of the subject that may occur while riding through brightly lit and shady regions from the type of pupil dilation of the eyes of the subject that may occur in an instance in which the subject has experienced head trauma, such as a concussion, following an accident.

While examples are provided above in conjunction with the manner in which the apparatus 20, such as the processor 22, may determine whether the subject is considered to require medical assistance based upon information provided by a gaze tracking system 18, the apparatus, such as the processor, may be considered to determine whether the subject requires medical assistance based upon the analysis of information provided by other types of interface systems 16. By way of example, the interface system may include a bone conduction audio system carried by a motorcycle helmet 10. In this embodiment, the apparatus, such as the processor, may be configured to determine that the subject requires medical assistance in an instance in which the bone conduction audio system provides information indicative of a period of prolonged groaning by the subject or in an instance in which the information is representative of audible request by the subject who specifically requests medical assistance. Still further, the apparatus, such as the processor, may be responsive to the information provided by a bone conduction audio system and may determine that medical assistance is required for a subject in an instance in which the information provided by a bone conduction audio system indicates that the subject fails to respond to an audible inquiry, such as an audible inquiry as to the well being of the subject.

As shown in block 38 of FIG. 3, the apparatus 20, such as the processor 22, the communication interface 26 or the like, may be configured to cause notification of a medical response service of the subject in an instance in which the subject is considered to require medical assistance. The apparatus, such as the processor, the communication interface or the like, may notify various medical response services, such as by placing a 911 or other emergency notification telephone call or by otherwise notifying one or more emergency or first response services, such as emergency medical technicians, police or fire department personnel or the like. The apparatus, such as the processor or the communications interface, may cause the medical response service to be notified in various manners, such as by placing a telephone call and causing provision of a message, such as a predefined message, notifying the medical response service of the subject in need of medical assistance. Additionally or alternatively, the apparatus, such as the processor, communication interface or the like, may cause notification to be provided by causing transmission of a text message, a short message service (SMS) message or other type of message. Regardless of the type of notification, the apparatus includes means, such as the processor, the communications interface or the like, for causing notification of a medical response service of the subject.

In one embodiment, the apparatus 20, such as the processor 22, the communication interface 26 or the like, may be further configured to cause information regarding the subject to be provided to the medical response service in the instance in which the subject is considered to require medical assistance. See block 40 of FIG. 3. The apparatus, such as the processor, the communications interface or the like, of this embodiment may cause various types of information regarding the subject to be provided, including information that may be useful to the first responders in regards to locating and/or treating the subject. For example, the information regarding the subject may include information regarding the location of the subject, the vital signs of the subject, demographic or other identification information of the subject or the like. In one embodiment, the subject may have caused predefined medical information to be stored in memory device 24 with the apparatus, such as the processor, the communication interface or the like, being configured to retrieve the medical information regarding the subject that is stored in the memory device and to cause this medical information to be provided to the medical response service. While the subject may cause a variety of different types of medical information to be stored, the subject may cause medical information that may be useful to the first responders to be stored, such as information indicating that the subject is a diabetic, is prone to seizure, is allergic to one or more medications, is currently taking one or more medications or the like. The apparatus may therefore include means, such as the processor, the communications interface or the like, for causing information regarding the subject to be provided to the medical response service to facilitate treatment of the subject.

In order to reduce the number of instances in which the apparatus 20, such as the processor 22, may inadvertently determine that the subject is considered to require medical assistance when, in fact, the subject does not require medical assistance, the apparatus, such as the processor or the like, may be configured as shown in block 36 of FIG. 3, to consider additional information regarding the subject in an instance in which the subject is considered, at least initially, to require medical assistance in order to confirm that the subject is considered to require medical assistance prior to causing notification of the medical response service. In this embodiment, the apparatus, such as the processor, the communications interface 26 or the like, may cause the medical response service to be notified in an instance in which the subject's need for medical assistance is confirmed, but may prevent notification of the medical response service in an instance in which the subject's need for medical assistance is not confirmed. The apparatus, such as the processor, of this embodiment may be configured to consider various types of additional information regarding the subject in order to confirm that the subject is considered to require medical assistance. Regardless of the type of additional information that is considered, the apparatus of this embodiment includes means, such as the processor or the like, for considering additional information regarding the subject in an instance in which the subject is considered, at least initially, to require medical assistance in order to confirm that the subject is considered to require medical assistance prior to causing notification of the medical response service.

In one embodiment, the apparatus 20, such as the processor 22, may be configured to consider information provided by one or more accelerometers. As such, in an instance in which the apparatus, such as the processor, determines that the subject is considered to require medical assistance, such as based upon information provided by a gaze tracking system 18, the apparatus, such as the processor, may be configured to confirm that the subject requires medical assistance by analyzing the information provided by one or more accelerometers to determine if the subject has recently experienced deceleration, such as may be created by an accident. In this instance, the apparatus, such as the processor, may only confirm that the subject requires medical assistance and notify the medical response service if the information provided by the accelerometer(s) indicate that the subject also recently experienced deceleration. Additionally or alternatively, the apparatus, such as the processor, may be configured to consider information provided by one or more audio transducers in order to confirm that the subject is considered to require medical assistance. In this example, the apparatus, such as the processor, may initially determine that the subject is considered to require medical assistance based upon information provided by a gaze tracking system. The apparatus, such as the processor, the communication interface 26 or the like, of this embodiment may then generate audio signals that may be produced by the audio transducers of the head worn device requesting that the subject respond in a manner that indicates whether or not the subject requires medical assistance. The audio transducers of this embodiment may therefore provide information indicative of a failure of the subject to respond to the audio inquiry or indicative of a response by the subject indicating that the subject does require medical assistance such that the requirement for medical assistance is confirmed and the medical response service is notified. Conversely, an audible response by the subject indicating that medical assistance is unnecessary may cause the apparatus, such as the processor, to prevent notification of the medical response service.

A method, apparatus and computer program product are therefore provided in accordance with an example embodiment in order to provide more timely notification of a medical response service of a subject who may require medical assistance. Moreover, the method, apparatus and computer program product of an example embodiment are not dependent upon the discovery of the subject requiring medical assistance by another person, but may independently and automatically notify the medical response service of the subject who may require medical assistance, even in an instance in which the subject is unable to initiate or otherwise participate in the notification of the medical response service. Thus, the method, apparatus and computer program product of an example embodiment may allow the subject to receive more timely medical assistance which may, in some instances, facilitate the subject's recovery from their medical condition.

As described above, FIG. 3 illustrates a flowchart of an apparatus 20, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 24 of an apparatus 20 employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the operations associated with the blocks with dashed outlines in the flowchart of FIG. 3. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving information regarding a subject from an interface system carried by a head worn device of the subject, wherein the information provided by the interface system is utilized for non-medical purposes;
determining, with a processor, whether the subject is considered to require medical assistance based upon the information regarding the subject; and
causing notification of a medical response service of the subject in an instance in which the subject is considered to require medical assistance.

2. A method according to claim 1 wherein the interface system comprises a gaze tracking system, and wherein determining whether the subject is considered to require medical assistance comprises determining whether the subject is considered to have become impaired based upon information regarding the subject provided by the gaze tracking system.

3. A method according to claim 2 wherein determining whether the subject is considered to have become impaired comprises determining whether the subject is considered to require medical assistance based upon a comparison of a length of time that the eyes of the subject remain closed relative to a predefined threshold.

4. A method according to claim 2 wherein determining whether the subject is considered to have become impaired comprises determining whether the subject is considered to require medical assistance based upon pupil dilation of the eyes of the subject.

5. A method according to claim 1 further comprising considering additional information regarding the subject in an instance in which the subject is considered to require medical assistance in order to confirm that the subject is considered to require medical assistance prior to causing notification of the medical response service.

6. A method according to claim 1 wherein the head worn device is configured for use by the subject during performance of a predefined activity, and wherein the method further comprises utilizing the information provided by the interface system during performance of the predefined activity for non-medical purposes.

7. A method according to claim 6 wherein the interface system is carried by a helmet worn by the subject.

8. An apparatus comprising at least one processor and at least one memory including computer program code, the at least one memory and the computer program code configured to, with the processor, cause the apparatus to at least:
receive information regarding a subject from an interface system carried by a head worn device of the subject, wherein the information provided by the interface system is utilized for non-medical purposes;
determine whether the subject is considered to require medical assistance based upon the information regarding the subject; and
cause notification of a medical response service of the subject in an instance in which the subject is considered to require medical assistance.

9. An apparatus according to claim 8 wherein the interface system comprises a gaze tracking system, and wherein the at least one memory and the computer program code are configured to, with the processor, cause the apparatus to determine whether the subject is considered to require medical assistance by determining whether the subject is considered to have become impaired based upon information regarding the subject provided by the gaze tracking system.

10. An apparatus according to claim 9 wherein the at least one memory and the computer program code are configured to, with the processor, cause the apparatus to determine whether the subject is considered to have become impaired by determining whether the subject is considered to require medical assistance based upon a comparison of a length of time that the eyes of the subject remain closed relative to a predefined threshold.

11. An apparatus according to claim 9 wherein the at least one memory and the computer program code are configured to, with the processor, cause the apparatus to determine whether the subject is considered to have become impaired by determining whether the subject is considered to require medical assistance based upon pupil dilation of the eyes of the subject.

12. An apparatus according to claim 8 wherein the at least one memory and the computer program code are further configured to, with the processor, cause the apparatus to consider additional information regarding the subject in an instance in which the subject is considered to require medical assistance in order to confirm that the subject is considered to require medical assistance prior to causing notification of the medical response service.

13. An apparatus according to claim 8 wherein the head worn device is configured for use by the subject during performance of a predefined activity, and wherein the at least one memory and the computer program code are further configured to, with the processor, cause the apparatus to utilize the information provided by the interface system during performance of the predefined activity for non-medical purposes.

14. An apparatus according to claim 13 wherein the interface system is carried by a helmet worn by the subject.

15. A computer program product comprising at least one non-transitory computer-readable storage medium having computer-executable program code portions stored therein, the computer-executable program code portions comprising program code instructions for:
receiving information regarding a subject from an interface system carried by a head worn device of the subject, wherein the information provided by the interface system is utilized for non-medical purposes;
determining whether the subject is considered to require medical assistance based upon the information regarding the subject; and
causing notification of a medical response service of the subject in an instance in which the subject is considered to require medical assistance.

16. A computer program product according to claim 15 wherein the interface system comprises a gaze tracking system, and wherein the program code instructions for determining whether the subject is considered to require medical assistance comprise program code instructions for determining whether the subject is considered to have become impaired based upon information regarding the subject provided by the gaze tracking system.

17. A computer program product according to claim 16 wherein the program code instructions for determining whether the subject is considered to have become impaired comprise program code instructions for determining whether the subject is considered to require medical assistance based upon a comparison of a length of time that the eyes of the subject remain closed relative to a predefined threshold.

18. A computer program product according to claim 16 wherein the program code instructions for determining whether the subject is considered to have become impaired comprise program code instructions for determining whether the subject is considered to require medical assistance based upon pupil dilation of the eyes of the subject.

19. A computer program product according to claim 15 wherein the computer-executable program code portions further comprise program code instructions for considering additional information regarding the subject in an instance in which the subject is considered to require medical assistance in order to confirm that the subject is considered to require medical assistance prior to causing notification of the medical response service.

20. A computer program product according to claim 15 wherein the head worn device is configured for use by the subject during performance of a predefined activity, and wherein the computer-executable program code portions further comprise program code instructions for utilizing the information provided by the interface system during performance of the predefined activity for non-medical purposes.
